(19) United States
(12) Patent Application Publication
(10) Pub. No.: US 2018/0048073 A1
(43) Pub. Date: Feb. 15, 2018

(54) DISTORTIONLESS ANTENNA DESIGN AND METHOD

(71) Applicant: The Governors of the University of Alberta, Edmonton (CA)

(72) Inventors: Kevin Chan, Edmonton (CA); Rambabu Karumudi, Edmonton (CA); Pierre Boulanger, Edmonton (CA)

(73) Assignee: The Governors of the University of Alberta, Edmonton, AB (CA)

(21) Appl. No.: 15/673,862

(22) Filed: Aug. 10, 2017

(30) Foreign Application Priority Data
Aug. 11, 2016 (CA) 2938901

(51) Int. Cl. H01Q 17/00; H01Q 1/52; H01Q 21/29; H01Q 19/02; H01Q 1/38; H01Q 1/42

(52) U.S. Cl. CPC H01Q 17/001; H01Q 1/38; H01Q 1/42; H01Q 21/29; H01Q 19/021; H01Q 1/521

(57) ABSTRACT

An antenna that radiates non-dispersive and time-aligned wave-fronts at all angles of radiation (in a half space). The antenna consists of a source radiator enclosed within a metallic shield with an aperture opening to couple plane waves radiated by the source through the aperture. Pulse dispersion is eliminated by having a truly planar aperture, resulting in an abrupt radiation zone, and the aperture field distribution being uniform. Wave-front alignment is caused by the continuity of the coupled electric field lines of force onto the metallic shield to result in radiated spherical waves. The antenna transfer function is impulse-like for all angles of radiation, thus it can be considered a distortion-less antenna.

### TECHNICAL FIELD

Limited dispersion antennas.

### BACKGROUND

Pulse radiating (wideband or ultra-wideband) antennas tend to be dispersive and not time aligned as the angle departs from the boresight radiation direction in the elevation, azimuth or both principal planes (including all angles in between). Example antennas that exhibit such behavior include the ridged-horn, pyramidal horn, sectorial horn, TEM horn, Vivaldi, bi-conical, disc-cone, bow-tie, log-periodic, spiral, circular slot, and etc. where the phase center for each of the antennas are spread out spatially along the radiating structure at different frequencies. Generally, broadband radiating structures incorporate a taper of sorts to support the wide frequency of operation and the electric-field pattern at its radiating aperture is non-uniform. The main contributions to off-angle dispersion and non-alignment in time are the non-stationary phase center location with respect to frequency and the inherent effect due to the antenna's radiation pattern/antenna's transfer function as defined by its physical structure. The term “boresight direction” refers to an axis of maximum gain of an antenna. For the purposes of this document, the statement that an antenna has a boresight direction should not be taken to indicate that the antenna is directional, and in the event that an antenna is not directional, all directions in which radiation is emitted should be taken to be boresight directions.

For imaging systems using pulsed radar, it is desired for the antenna transfer function to be “transparent” or impulse-like, so that further processing to deconvolute the antenna's transfer function is unnecessary which can speed up processing and reduce the system's complexity.

For narrow-band systems, off-angle phase distortions (effect of radiation pattern) can cause synchronous systems to lose synchrony for mobile stations in motion when the direction of arrival to fixed base stations changes over time. Therefore, the dispersion and time alignment problem applies generally for most antenna types.

A method to reduce antenna dispersion is disclosed in U.S. Pat. No. 8,090,040 B2 by the application of pre- or post-distortion to the antenna transfer function through the use of equalization filters. This method limits dispersion in the boresight angle (and thus limited angles) only.

U.S. Pat. No. 5,754,144 describes a non-dispersive pulse radiating antenna whereby the dispersion is “eliminated” by having an “abrupt radiator” inset within a metallic horn structure. The “launcher plate” together with the optional “broadbanding fin” that forms the “abrupt radiator” still presents a finite length radiating structure which constitutes to off-angle pulse dispersion. The measured pulse stated in the disclosure is for boresight radiation, and no further detail was given for off-angle pulse dispersion. The true elimination of off-angle pulse dispersion will be that of a planar aperture type which does not have a 3-D profile.

U.S. Pat. No. 6,845,253 disclosed an antenna that is non-dispersive, but only in the directions of omni-directionality. It is essentially a dipole type of broadband antenna which will suffer dispersion in the orthogonal plane to its omni-directional radiation.

### SUMMARY

Embodiments of the claimed invention may address one or more of the following objectives: to reduce antenna dispersion at off-boresight angles, to produce time-aligned pulses/radiated signals at all angles of radiation, and to have an antenna transfer function that is close to an impulse, such that it will radiate a signal that is a replica of what is fed to its input terminal (i.e. distortionless).

In an embodiment, there is disclosed an antenna, comprising a source radiator for generating radiated radio waves; a metallic shield having a front surface facing away from the source radiator and defining a circular aperture having a diameter equivalent to or smaller than a highest frequency wavelength of the radiated wave, the aperture defining an axis generally aligned with the source radiator and the aperture spaced from the source radiator in a direction aligned with the axis, and the size of the front surface as projected onto a plane perpendicular to the axis being equivalent to or larger than a lowest frequency wavelength of the radiated wave; and microwave absorbers lining at least a portion of a surface of the metallic shield.

In various embodiments, which may be combined in any combination, there is disclosed: the front surface is planar, apart from the aperture the metallic shield fully encloses the source radiating antenna, the source radiating antenna has a boresight direction aligned with the axis, the spacing of the aperture from the source antenna in the direction aligned with the axis is greater than or equal to a far field distance, where the far field distance is a Fraunhofer distance of the source antenna, and where the Fraunhofer distance is defined using the highest frequency wavelength of the radiated wave, the spacing of the aperture from the source antenna in the direction aligned with the axis is greater than or equal to a far field distance, where the far field distance is defined as a distance for stable pulse shape of the radiated wave, all surfaces of the metallic shield facing the source radiating antenna are lined with microwave absorbers, the metallic shield is connected to a circuit ground of the source radiator or to the potential of the earth by means of electric conduction via physical contact or cables, an electromagnetically transparent board or insert for supporting the source radiator onto a rigid structure of the metallic shield.

### BRIEF DESCRIPTION OF THE FIGURES

Embodiments will now be described with reference to the figures, in which like reference characters denote like elements, by way of example, and in which:

FIG. 1 is a perspective view of an embodiment of an antenna.

FIG. 2 is a plot of a source pulse that was used to drive the antenna in a test.

### DETAILED DESCRIPTION

There is provided a new antenna design that radiates with minimal dispersion, time aligned wave fronts and is distortionless for all angles of radiation.

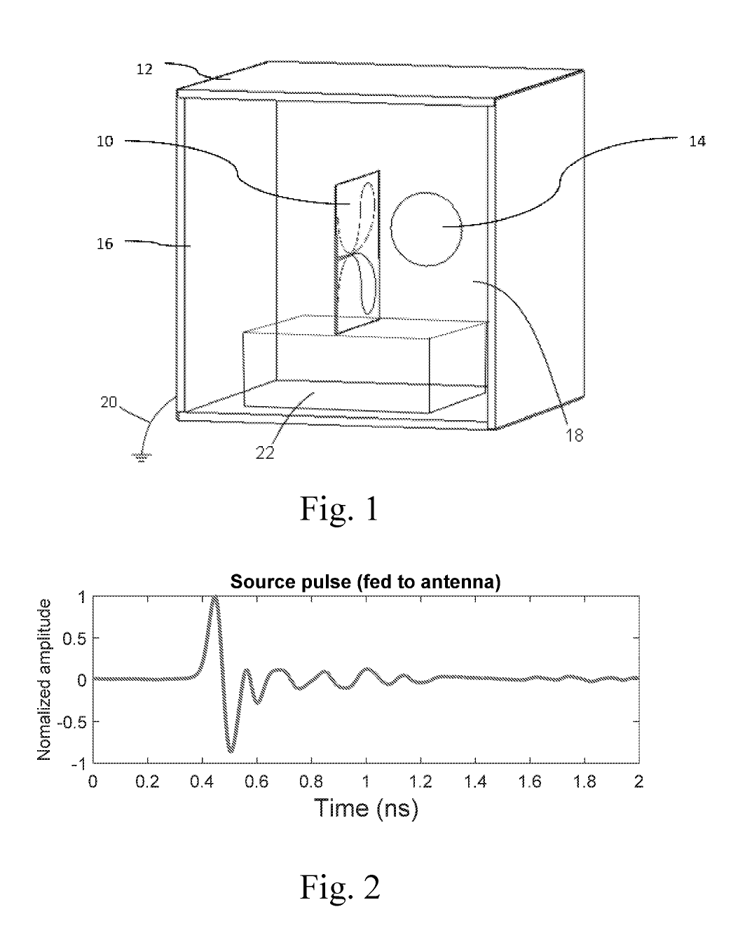

FIG. 1 shows a perspective view of one embodiment of an antenna. A source pulse is fed to an anti-podal Vivaldi antenna 10 to radiate a plane wave that will be coupled across an aperture opening 14 in a metallic shield/cavity 12. The aperture 14 is located in front portion 18 of metallic shield 12. Front portion 18 has a front surface facing away from the source radiator 10, the front surface in this embodiment being planar. The apparatus shown radiates pulses with minimal dispersion because the radiating aperture is truly planar/abrupt and the aperture field distribution is uniform.

The source radiating antenna 10 is not restricted to just anti-podal Vivaldi antenna type, and is generally any antenna, narrow band or wide band, directional or omni-directional, that is capable of generating the plane wave that is to be coupled through the aperture 14. Therefore, other embodiments include, in general, any antenna or device that radiates microwaves as the source antenna. The wave need only be approximately planar not exactly so, and a non-planar wave will approximate a plane wave over a small transverse distance such as aperture opening 14 as long as there is sufficient distance between the source of the wave and the location at which deviations from a plane wave is considered (far-field distance). Thus, it is not necessary for the wave as generated by the source radiating antenna 10 to be a plane wave.

The metallic shield/cavity 12 is lined partially/fully (apart from the aperture 14) with microwave absorbers 16 at the inside/inner surface of the shield/cavity 12, for the purpose of preventing field leakage to the outside of the shield 12. The microwave absorber 16 is of the type that causes sufficient attenuation (at least 10 dB) to microwave reflections for waves impinging its surface, and negligible waves transmit through its material (i.e. lossy). A representative microwave absorber 16 can be the Eccosorb® FGMU-125 from Emerson & Cuming Microwave Products Inc., but is not limited to this material. Any technology that can achieve the same function of absorbing microwaves and preventing leakage to the outside of the shield is included in the described embodiment.

The shield 12 may be a metallic cavity enclosing the source radiator 10, and the shape is not confined to a cube. Other possible shapes for the shield 12 included in this embodiment can be with rounded edges, as opposed to the sharp edges shown in FIG. 1, and can also be for example a cylinder, as long as the dimensions of the shield 12 meet the requirements stated in the following statements. The description of the embodiment shown in FIG. 1 has the shield 12 uncovered in the back direction of the antenna, but another embodiment includes a fully enclosed shield (with no other openings apart from the aperture 14). The shield 12 can be un-grounded or grounded to the circuit ground or the earth. An example cable grounding the shield is labeled with reference numeral 20,

The source radiator 10 can be held in place within the shield 12 by means of an electromagnetically transparent board or block 22 that is supported by the shield 12, or the source radiator 10 can be mounted directly onto the shield 12 for support. Polystyrene foam (e.g. Styrofoam™) is considered an example of a suitable material for this purpose. The ground cable and electromagnetically transparent block in FIG. 1 are shown as examples only and are not necessarily representative of the experimental setup which was tested.

The distance between the aperture 14 and the source radiator 10 is set in an embodiment at the far-field distance of the source radiator 10, but is not limited to this minimum distance. Near-field coupling is also included in an embodiment of the invention, with the limitation that the resulting radiated pulse shape will not be the same as for the far-field coupling condition. Traditionally for narrow band antennas, far-field distance (Fraunhofer region) is defined as

$$d = \frac{2 {D}^{2}}{λ} ,$$

where D is the largest dimension of the radiator and λ is a wavelength of the radio wave. For ultra-wideband antennas, the far-field is defined when the radiated pulse shape is stable, i.e. time derivative of the input pulse, which is applied here.

The maximum size of the aperture 14 corresponds to the free-space wavelength of the highest frequency component of the incident plane wave radiated from the source 10, and the minimum size of the metallic shield 12 corresponds to the wavelength of the lowest frequency component. The reason for the aperture 14 size set at the wavelength of the highest frequency component is because a larger size will start to introduce side-lobes in the radiation patterns for higher frequency components and in result cause pulse dispersion and distortion. Additionally, if the metallic shield 12 is truncated to a size smaller than the wavelength of the lowest frequency component, the reflection from the edges for low frequency components (abrupt change in phase) will cause destructive interference at the far-field thus distorting the radiated pulse.

As the plane wave travels across the aperture 14 opening, the surrounding metallic shield 12 provides continuity for the electric field (lines of force) and supports the radiation as the radiated wave spread out toward the periphery of the shield 12. This arrangement creates the shape of the wave front, when the plane wave is coupled across the aperture 14, to be circular and thus maintains time alignment for all angles of radiation. Therefore, the metallic shield 12 is a part of the radiating structure.

Received pulses were measured, for radiation from the embodiment of the invention as described by FIG. 1, at various angles of radiation in a test. The source pulse, as represented by the graph in FIG. 2, is fed into the source antenna 10. It was found that the received pulses were time aligned and had very limited dispersion for all angles of radiation. The pulse shape was preserved (i.e. distortionless) and the amplitude distribution is related to a cosine function with respect to the radiation angle.

The aperture 14 coupling mechanism through the shield 12 will cause an order of differentiation to the incident pulse. Therefore, together with the differentiation of the source pulse by the source antenna 10, there will be two orders of differentiation for the pulse radiated by the invention. The pulse shape for two orders of differentiation as compared to source pulse is almost identical, apart from additional slight overshoots of pulse ringing. In terms of pulse fidelity as compared to the source pulse, the radiated pulse by the embodiment of the invention is 94% as compared to 83% for a pulse radiated by an anti-podal Vivaldi antenna 10 in the boresight direction. The reason why the Vivaldi antenna has a lower pulse fidelity is due to an odd order of differentiation as compared with the source pulse. This shows that the antenna transfer function of the invention is approximately an impulse for all angles, thus it is deemed to be “transparent” to the system and can be considered as a distortionless antenna.

One possible use of the invention is to be deployed as the transmitting antenna for pulsed microwave imaging systems due to its unique radiation characteristics, being truly omni-directional in a half-space. Moreover, the distortionless pulse radiation simplifies signal processing for the imaging system because the antenna transfer function, being impulse-like, does not need to be deconvoluted from the received pulse function.

Another use for the invention can be for the cellular network base station transmitting antenna or for the transmitting antenna of Wi-Fi routers, to provide a better coverage area due to the antenna's radiation characteristics. Modifications to existing antennas mounted on infra-structure by adding the shield component 12 with aperture 14 will also realize an embodiment of this invention.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. An antenna, comprising:
a source radiator for generating radiated radio waves;
a metallic shield having a front surface facing away from the source radiator and defining a circular aperture having a diameter equivalent to or smaller than a highest frequency wavelength of the radiated wave, the aperture defining an axis generally aligned with the source radiator and the aperture spaced from the source radiator in a direction aligned with the axis, and the size of the front surface as projected onto a plane perpendicular to the axis being equivalent to or larger than a lowest frequency wavelength of the radiated wave; and
microwave absorbers lining at least a portion of a surface of the metallic shield.

2. The antenna of claim 1 in which the front surface is planar.

3. The antenna of claim 1 in which apart from the aperture the metallic shield fully encloses the source radiating antenna.

4. The antenna of claim 1 in which the source radiating antenna has a boresight direction aligned with the axis.

5. The antenna of claim 1 in which the spacing of the aperture from the source antenna in the direction aligned with the axis is greater than or equal to a far field distance, where the far field distance is a Fraunhofer distance of the source antenna, and where the Fraunhofer distance is defined using the highest frequency wavelength of the radiated wave.

6. The antenna of claim 1 in which the spacing of the aperture from the source antenna in the direction aligned with the axis is greater than or equal to a far field distance, where the far field distance is defined as a distance for stable pulse shape of the radiated wave.

7. The antenna of claim 1 in which all surfaces of the metallic shield facing the source radiating antenna are lined with microwave absorbers.

8. The antenna of claim 1 in which the metallic shield is connected to a circuit ground of the source radiator or to the potential of the earth by means of electric conduction via physical contact or cables.

9. The antenna of claim 1 further comprising an electromagnetically transparent board or insert for supporting the source radiator onto a rigid structure of the metallic shield.

10. The antenna of claim 2 in which apart from the aperture the metallic shield fully encloses the source radiating antenna.

11. The antenna of claim 10 in which the source radiating antenna has a boresight direction aligned with the axis.

12. The antenna of claim 11 in which the spacing of the aperture from the source antenna in the direction aligned with the axis is greater than or equal to a far field distance, where the far field distance is a Fraunhofer distance of the source antenna, and where the Fraunhofer distance is defined using the highest frequency wavelength of the radiated wave.

13. The antenna of claim 12 in which the spacing of the aperture from the source antenna in the direction aligned with the axis is greater than or equal to a far field distance, where the far field distance is defined as a distance for stable pulse shape of the radiated wave.

14. The antenna of claim 13 in which all surfaces of the metallic shield facing the source radiating antenna are lined with microwave absorbers.

15. The antenna of claim 14 in which the metallic shield is connected to a circuit ground of the source radiator or to the potential of the earth by means of electric conduction via physical contact or cables.

16. The antenna of claim 15 further comprising an electromagnetically transparent board or insert for supporting the source radiator onto a rigid structure of the metallic shield.
